(19) United States
(12) Patent Application Publication
(10) Pub. No.: US 2009/0145356 A1
(43) Pub. Date: Jun. 11, 2009

(54) Supporting device having a repositionable suction base for an air spray gun

(76) Inventor: Jet C. Lai, Taichung City (TW)

Correspondence Address: THE WEBB LAW FIRM, P.C., 700 KOPPERS BUILDING, 436 SEVENTH AVENUE, PITTSBURGH, PA, 15219, US

(21) Appl. No.: 12/001,181

(22) Filed: Dec. 10, 2007

(51) Int. Cl. B05B 13/04

(52) U.S. Cl. 118/305; 118/680

(57) ABSTRACT

A supporting device includes a suction base having a central base body interconnecting opposite suction units operable between non-sucking and sucking states. A supporting unit includes a rod-mounting seat having a connecting end portion disposed in a pivot groove in a top side of the central base body and connected pivotally to the central base body, and a mounting end portion disposed outwardly of the pivot groove and mounted rotatably with a supporting rod therein. The rod-mounting seat is positioned adjustably at a desired angular position relative to the central base body. A gun-mounting unit is mounted on the supporting rod, and is mounted with an air spray gun thereon.

### BACKGROUND OF THE INVENTION

1. Field of the Invention

The invention relates to a supporting device, more particularly to a supporting device for an air spray gun.

2. Description of the Related Art

Referring to FIG. 1, a conventional air spray gun assembly is shown to include a supporting frame 6 and a plurality of air spray guns 5. The supporting frame 6 includes a base frame portion 61, an upright main supporting rod 62 mounted on the base frame portion 61, a mounting seat 63 mounted on the main supporting rod 62, and an elongate mounting rod 64 extending through the mounting seat 63. The air spray guns 5 are mounted on the mounting rod 64.

When the air spray guns 5 of the conventional air spray gun assembly are used for drying paint coated on a car body (not shown), the base frame portion 61 is preferably placed on a horizontal surface, such as a ground surface, and cannot be effectively positioned. Therefore, adjustment of the air spray guns 5 to positions close to the car body is difficult and cannot be ensured, thereby resulting in an inferior air-drying efficiency. Furthermore, damage to the car body resulting from falling of the supporting frame 6 cannot be avoided.

### SUMMARY OF THE INVENTION

Therefore, the object of the present invention is to provide a supporting device for an air spray gun that can overcome the aforesaid drawbacks of the prior art.

According to one aspect of the present invention, there is provided a supporting device for an air spray gun. The supporting device comprises:

a suction base including
two suction units opposite to each other in a first direction, each of the suction units being operable between a non-sucking state and a sucking state, and
a central base body having opposite lateral end portions connected respectively to the suction units, and a top side formed with a pivot groove that extends in the first direction;

a supporting unit including
a rod-mounting seat having a connecting end portion disposed in the pivot groove in the central base body and connected pivotally to the central base body such that the connecting end portion is pivotable relative to the central base body about a pivot axis perpendicular to the first direction, and a mounting end portion connected fixedly to the connecting end portion and disposed outwardly of the pivot groove in the central base body, the rod-mounting seat being positioned adjustably at a desired angular position relative to the central base body, and
an elongate supporting rod having an end mounted rotatably at the mounting end portion of the rod-mounting seat; and

a gun-mounting unit mounted on the supporting rod and adapted to be mounted with the air spray gun thereon.

According to another aspect of the present invention, an air spray gun assembly comprises:

an air spray gun; and

a supporting device for supporting the air spray gun thereon, the supporting device including
a suction base including
   two suction units opposite to each other in a first direction, each of the suction units being operable between a non-sucking state and a sucking state, and
   a central base body having opposite lateral end portions connected respectively to the suction units, and a top side formed with a pivot groove that extends in the first direction,
a supporting unit including
   a rod-mounting seat having a connecting end portion disposed in the pivot groove in the central base body and connected pivotally to the central base body such that the connecting end portion is pivotable relative to the central base body about a pivot axis perpendicular to the first direction, and a mounting end portion connected fixedly to the connecting end portion and disposed outwardly of the pivot groove in the central base body, the rod-mounting seat being positioned adjustably at a desired angular position relative to the central base body, and
   an elongate supporting rod having an end mounted rotatably at the mounting end portion of the rod-mounting seat, and
a gun-mounting unit mounted on the supporting rod and mounted with the air spray gun thereon.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional air spray gun assembly;

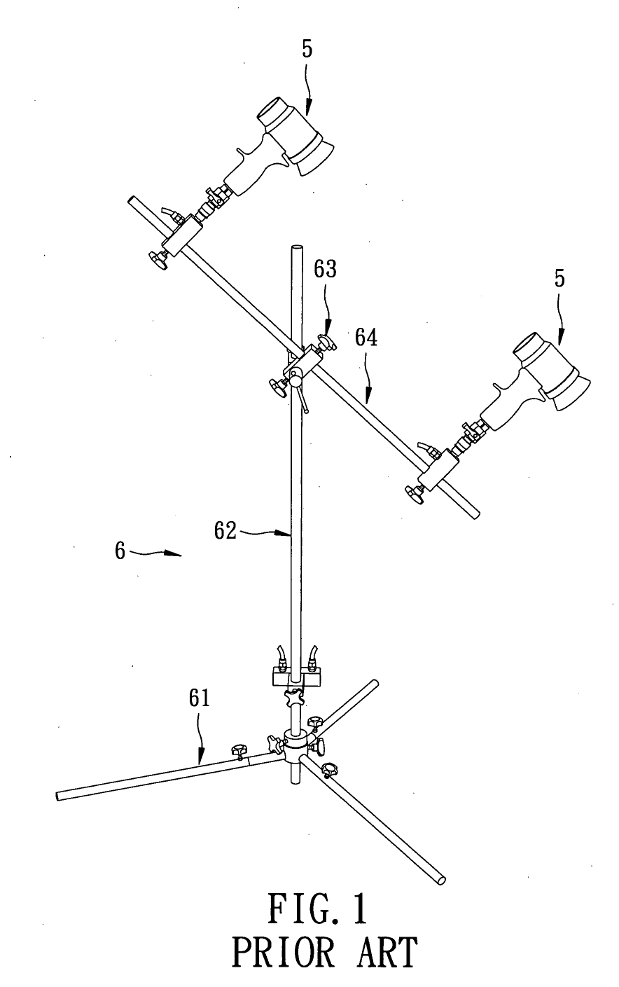

FIG. 2 is a perspective view showing the preferred embodiment of an air spray gun assembly according to the present invention;

FIG. 3 is a fragmentary, partly sectional schematic view showing a suction base and a supporting unit of the preferred embodiment when two suction units are operated in a non-sucking state;

FIG. 4 is a fragmentary, partly sectional schematic view showing the suction base and the supporting unit of the preferred embodiment when the suction units are operated in a sucking state;

FIG. 5 is a fragmentary, partly sectional schematic view showing a supporting rod, a gun-mounting unit and an air spray gun of the preferred embodiment; and

FIG. 6 is a perspective view showing the preferred embodiment when in a state of use.

### DETAILED DESCRIPTION OF THE PREFERRED EMBODIMENT

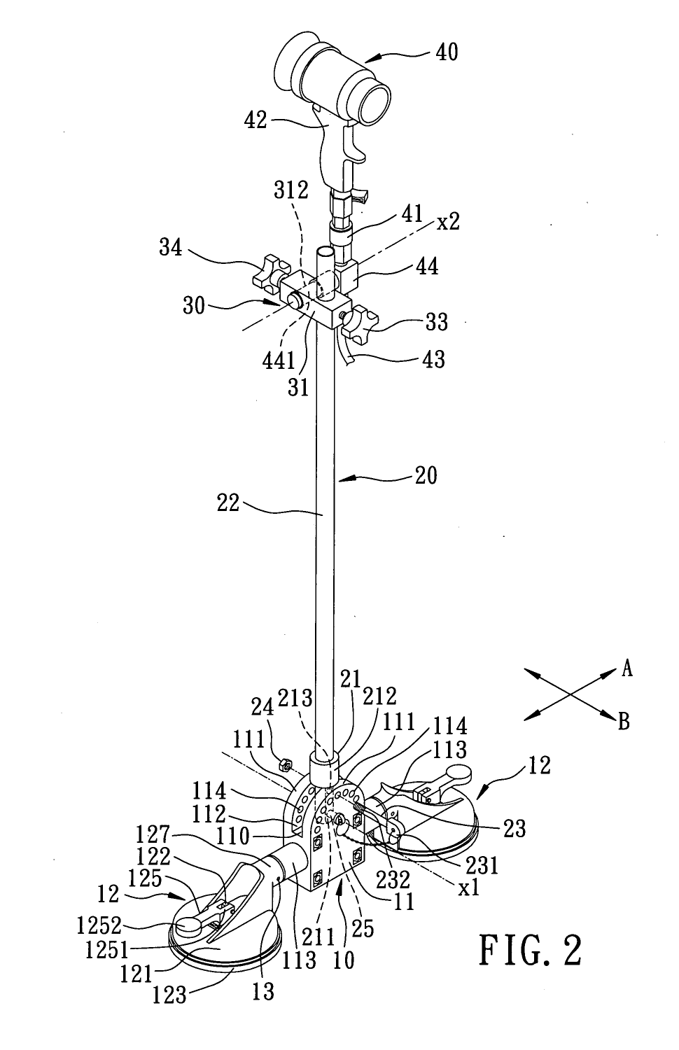

Referring to FIG. 2, the preferred embodiment of an air spray gun assembly according to the present invention is shown to include an air spray gun 40, and a supporting device for supporting the air spray gun 40 thereon.

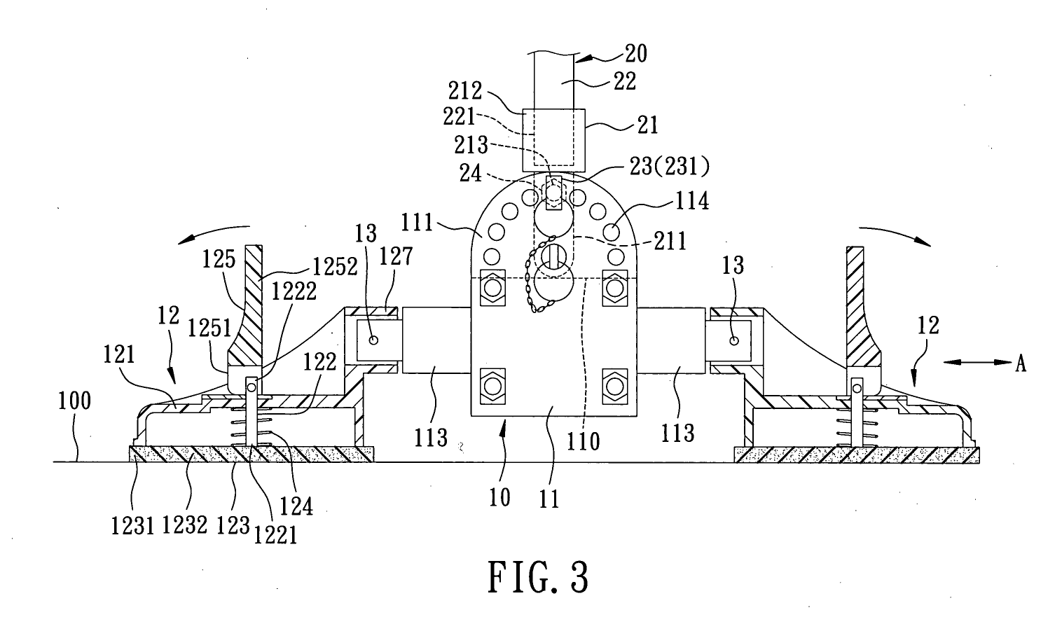

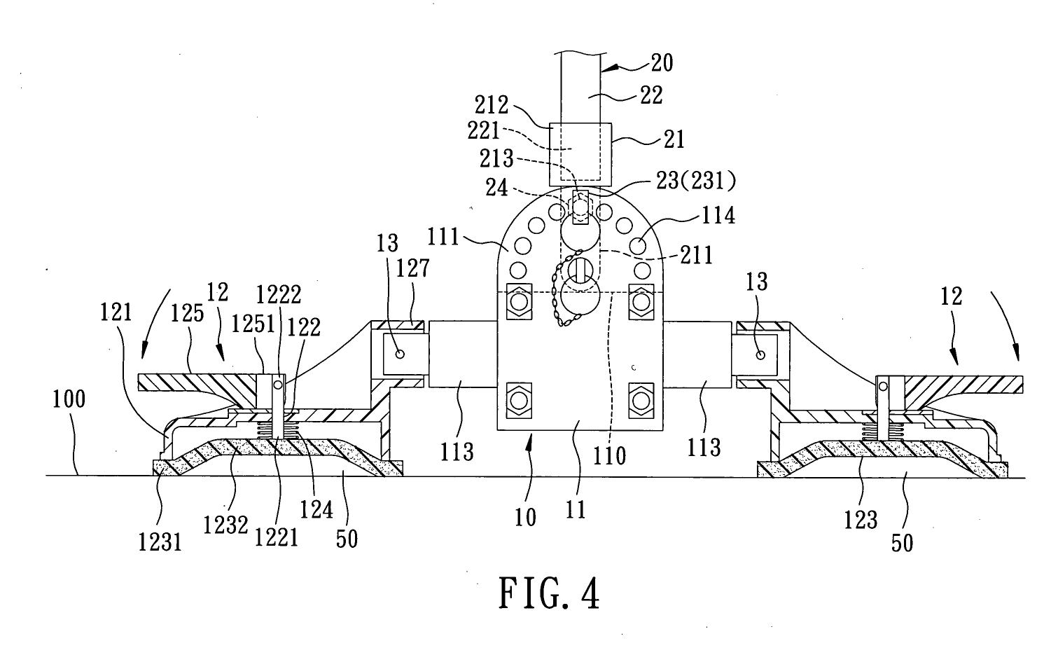

Referring further to FIGS. 3 and 4, the supporting device includes a suction base 10, a supporting unit 20 and a gun-mounting unit 30.

The suction base 10 includes a central base body 11, and two suction units 12 opposite to each other in a first direction (A). The central base body 11 has opposite cylindrical lateral end portions 113, and a top side formed with a pivot groove 112 that extends in the first direction (A) and that is defined by two parallel side walls 111 opposite to each other in a second direction (B) perpendicular to the first direction (A), and a groove bottom wall 110 interconnecting the side walls 111, as shown in FIG. 2. In this embodiment, each side wall 111 is formed with a plurality of positioning holes 114 spaced apart from each other.

Each suction unit 12 is operable between a non-sucking state and a sucking state, and includes a cap body 121, a flexible sucking disc 123, a connecting rod 122 and an operating member 125. For each suction unit 12, the cap body 121 has a connecting portion 127 in the form of a sleeve sleeved around a corresponding one of the lateral end portions 113 of the central base body 11 in a loose fitting manner. More specifically, the suction base 10 further includes two connecting pins 13 each extending in the second direction (B) and through a corresponding one of the lateral end portions 113 of the central base body 11 and the connecting portion 127 of the cap body 121 of a corresponding one of the suction units 12 such that the cap bodies 121 are pivotable relative to the lateral end portions 113 of the central base body 11 about the connecting pins 13, respectively. The sucking disc 123 has a peripheral portion 1231 that is adapted to be attached sealingly to a supporting surface 100 (see FIG. 3) and that abuts against the cap body 121, and a central portion 1232 connected integrally to the peripheral portion 1231 and adapted to be spaced apart from the supporting surface 100 (see FIG. 4). The connecting rod 122 has a first end 1221 connected to the central portion 1232 of the sucking disc 123, and a second end 1222 opposite to the first end 1221 and extending through the cap body 121. The operating member 125 has a cam end portion 1251 connected pivotally to the second end 1222 of the connecting rod 122 and abutting against the cap body 121, and an operating end portion 1252 opposite to the cam end portion 1222. Thus, when each of the suction units 12 is in the non-sucking state, the operating end portion 1252 of the operating member 125 is pivoted away from the cap body 121, as shown in FIG. 3, and when each of the suction units 12 is in the sucking state, the operating end portion 1252 of the operating member 125 is pivoted toward the cap body 121, and an assembly of the connecting rod 122 and the central portion 1232 of the sucking disc 123 is moved away from the supporting surface 100, thereby forming a vacant space 50 between the central portion 1232 of the sucking disc 123 and the supporting surface 100, as shown in FIG. 4. In this embodiment, each suction unit 12 further includes a coil spring 124 disposed between and abutting against the cap body 121 and the central portion 1232 of the sucking disc 123, and sleeved on the connecting rod 122 for biasing the central portion 1232 of the sucking disc 123 to move toward the supporting surface 100.

The supporting unit 20 includes a rod-mounting seat 21 and an elongate supporting rod 22. The rod-mounting seat 21 has a connecting end portion 211 and a hollow mounting end portion 212. The connecting end portion 211 of the rod-mounting seat 21 is disposed in the pivot groove 112 in the central base body 11, and is connected pivotally between the side walls 111 of the central base body 11 by a pivot pin 25 extending through the connecting end portion 211 and the side walls 111 such that the connecting end portion 211 is pivotable relative to the central base body 11 about a pivot axis (x1) of the pivot pin 25 perpendicular to the first direction (A), as shown in FIG. 2. The mounting end portion 212 is connected fixedly to the connecting end portion 211, and is disposed outwardly of the pivot groove 112 in the central base body 11. The rod-mounting seat 21 is positioned adjustably at a desired angular position relative to the central base body 11. In this embodiment, the supporting unit 20 further includes a positioning pin 23 extending through the connecting end portion 211 of the rod-mounting seat 21 and engaging removably a desired one of the positioning holes 114 in each side wall 111 such that the rod-mounting seat 21 is positioned at the desired angular position. The positioning pin 23 has a head portion 231 abutting against an outer surface of one of the side walls 111 of the central base body 11, and a threaded end portion 232 opposite to the head portion 231 and extending outwardly of the central base body 11. A nut 24 engages the threaded end portion 232 of the positioning pin 23, and abuts against an outer surface of the other one of the side walls 111 of the central base body 11 to thereby prevent removal of the positioning pin 23 from the central base body 11. The supporting rod 22 has an end 221 mounted rotatably in the mounting end portion 212 of the rod-mounting seat 21, and is pivotable about a central axis thereof, as shown in FIG. 3.

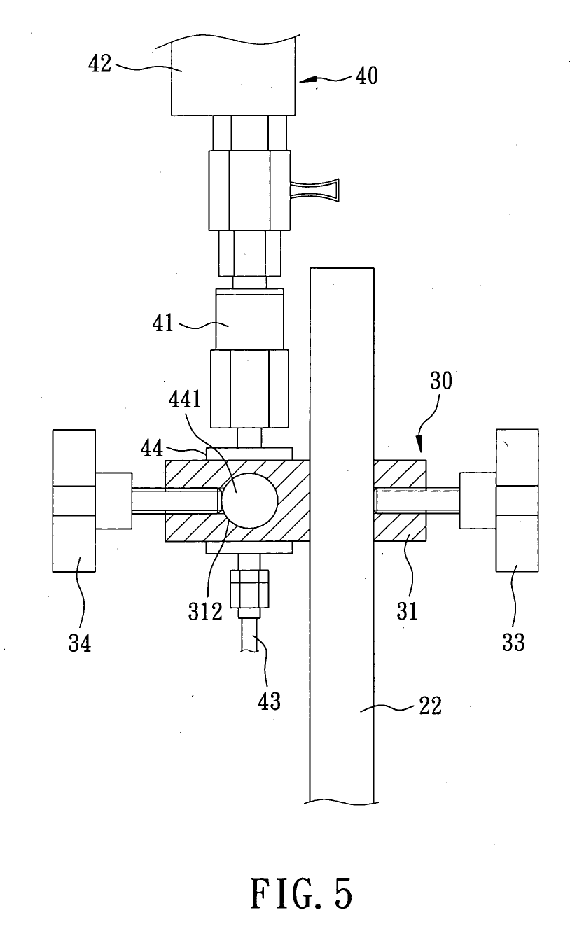

The gun-mounting unit 30 is mounted on the supporting rod 22. In this embodiment, referring further to FIG. 5, the gun-mounting unit 30 includes a mounting block 31, a first positioning member 33 and a second positioning member 34. The mounting block 31 is sleeved movably and rotatably on the supporting rod 22, and is formed with a through hole 312 that extends in a third direction perpendicular to the supporting rod 22. The first positioning member 33 is mounted on the mounting block 31, and is operable so as to position the mounting block 31 at a desired axial position on the supporting rod 22. The second positioning member 34 is mounted on the mounting block 31, and the function thereof will be described later.

The air spray gun 40 includes a hollow connecting body 44 having a connecting rod 441, a gun body 42 having a fitting 41 mounted rotatably on the connecting body 44, and an air pipe 43 mounted on the connecting body 44 and in spatial communication with the fitting 41 of the gun body 42. The connecting rod 441 extends through the through hole 312 in the mounting block 31 so that the air spray gun 40 is pivotable relative to the mounting block 31 about a central axis (x2) of the connecting rod 441. By operating the second positioning member 34, the air spray gun 40 can be positioned at a desired angular position relative to the mounting block 31.

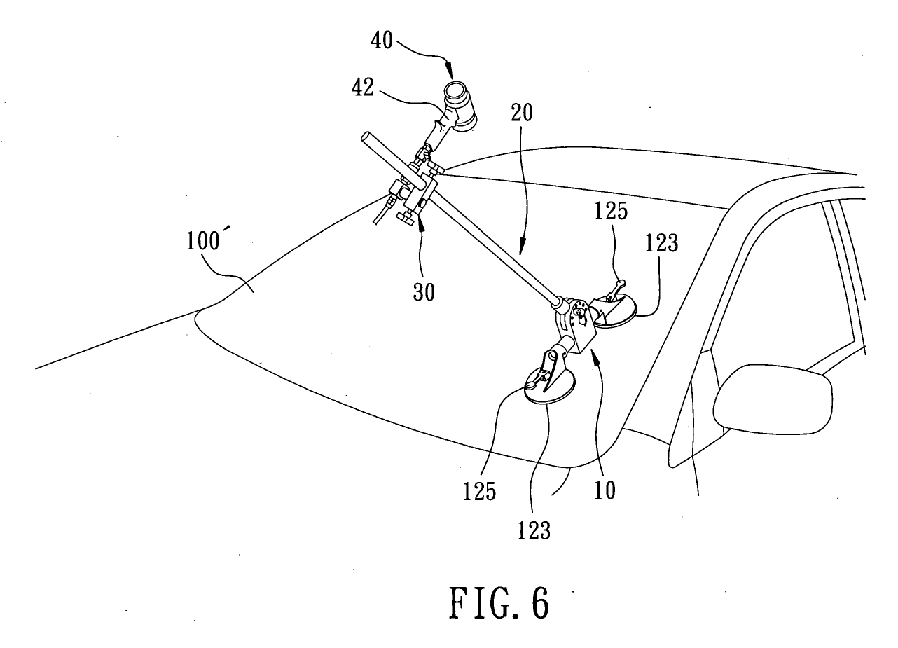

In use, as shown in FIG. 6, when the air spray gun 40 is used for drying paint coated on a car body, due to the presence of the suction units 12, the supporting device can be easily and stably positioned on a supporting surface, such as an outer surface 100′ of a windshield of the car body, such that appropriate adjustment of the air spray gun 40 can be ensured, thereby resulting in a superior air-drying efficiency.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A supporting device for an air spray gun comprising:
a suction base including
two suction units opposite to each other in a first direction, each of said suction units being operable between a non-sucking state and a sucking state, and
a central base body having opposite lateral end portions connected respectively to said suction units, and a top side formed with a pivot groove that extends in the first direction;
a supporting unit including
a rod-mounting seat having a connecting end portion disposed in said pivot groove in said central base body and connected pivotally to said central base body such that said connecting end portion is pivotable relative to said central base body about a pivot axis perpendicular to said first direction, and a mounting end portion connected fixedly to said connecting end portion and disposed outwardly of said pivot groove in said central base body, said rod-mounting seat being capable of being positioned adjustably at a desired angular position relative to said central base body, and
an elongate supporting rod having an end mounted rotatably at said mounting end portion of said rod-mounting seat, and pivotable about a central axis thereof; and
a gun-mounting unit mounted on said supporting rod and adapted to be mounted with the air spray gun thereon.

2. The supporting device as claimed in claim 1, wherein each of said suction units includes
a cap body having a connecting portion attached to a corresponding one of said lateral end portions of said central base body,
a flexible sucking disc having a peripheral portion that is adapted to be attached sealingly to a supporting surface and that abuts against said cap body, and a central portion connected integrally to said peripheral portion and adapted to be spaced apart from the supporting surface,
a connecting rod having a first end connected to said central portion of said sucking disc, and a second end opposite to said first end and extending through said cap body, and
an operating member having a cam end portion connected pivotally to said second end of said connecting rod and abutting against said cap body, and an operating end portion opposite to said cam end portion; and
wherein, when each of said suction units is in the non-sucking state, said operating end portion of said operating member is pivoted away from said cap body, and when each of said suction units is in the sucking state, said operating end portion of said operating member is pivoted toward said cap body, and an assembly of said connecting rod and said central portion of said sucking disc is moved away from the supporting surface, thereby forming a vacant space between said central portion of said sucking disc and the supporting surface.

3. The supporting device as claimed in claim 2, wherein each of said suction units further includes a coil spring disposed between and abutting against said cap body and said central portion of said sucking disc, and sleeved on said connecting rod for biasing said central portion of said sucking disc to move toward the supporting surface.

4. The supporting device as claimed in claim 2, wherein:
each of said lateral end portions of said central base body is cylindrical;
said connecting portion of said cap body of each of said suction units is in the form of a sleeve sleeved around the corresponding one of said lateral end portions of said central base body in a loose fitting manner; and
said suction base further includes two connecting pins each extending in a second direction perpendicular to said first direction and through a corresponding one of said lateral end portions of said central base body and said connecting portion of said cap body of a corresponding one of said suction units such that said suction units are pivotable relative to said lateral end portions of said central base body about said connecting pins, respectively.

5. The supporting device as claimed in claim 1, wherein:
said pivot groove in said central base body is defined by two parallel side walls opposite to each other in a second direction perpendicular to the first direction, and a groove bottom wall interconnecting said side walls, each of said side walls being formed with a plurality of positioning holes spaced apart from each other, said connecting end portion of said rod-mounting seat being connected pivotally between said side walls; and
said supporting unit further includes a positioning pin extending through said connecting end portion of said rod-mounting seat and engaging removably a desired one of said positioning holes in each of said side walls such that said rod-mounting seat is positioned at the desired angular position.

6. The supporting device as claimed in claim 5, wherein:
said positioning pin of said supporting unit has a head portion abutting against an outer surface of one of said side walls of said central base body of said suction base, and a threaded end portion opposite to said head portion and extending outwardly of said central base body; and
said supporting unit further includes a nut abutting against an outer surface of the other one of said side walls of said central base body of said suction base and engaging said threaded end portion of said positioning pin.

7. The supporting device as claimed in claim 1, wherein said gun-mounting unit includes:
a mounting block sleeved movably and rotatably on said supporting rod, and adapted to be mounted pivotably with the air spray gun thereon such that the air spray gun is pivotable relative to said mounting block about an axis perpendicular to said supporting rod;
a first positioning member mounted on said mounting block and operable so as to position said mounting block at a desired axial position on said supporting rod; and
a second positioning member mounted on said mounting block and operable so as to position the air spray gun at a desired angular position relative to said mounting block.

8. An air spray gun assembly comprising:
an air spray gun; and
a supporting device for supporting said air spray gun thereon, said supporting device including
a suction base including
two suction units opposite to each other in a first direction, each of said suction units being operable between a non-sucking state and a sucking state, and
a central base body having opposite lateral end portions connected respectively to said suction units, and a top side formed with a pivot groove that extends in the first direction,
a supporting unit including
a rod-mounting seat having a connecting end portion disposed in said pivot groove in said central base body and connected pivotally to said central base body such that said connecting end portion is pivotable relative to said central base body about a pivot axis perpendicular to said first direction, and a mounting end portion connected fixedly to said connecting end portion and disposed outwardly of said pivot groove in said central base body, said rod-mounting seat being capable of being positioned adjustably at a desired angular position relative to said central base body, and
an elongate supporting rod having an end mounted rotatably at said mounting end portion of said rod-mounting seat, and pivotable about a central axis thereof, and
a gun-mounting unit mounted on said supporting rod and mounted with said air spray gun thereon.

9. The air spray gun assembly as claimed in claim 8, wherein each of said suction units of said supporting device includes
a cap body having a connecting portion attached to a corresponding one of said lateral end portions of said central base body,
a flexible sucking disc having a peripheral portion that is adapted to be attached sealingly to a supporting surface and that abuts against said cap body, and a central portion connected integrally to said peripheral portion and adapted to be spaced apart from the supporting surface,
a connecting rod having a first end connected to said central portion of said sucking disc, and a second end opposite to said first end and extending through said cap body, and
an operating member having a cam end portion connected pivotally to said second end of said connecting rod and abutting against said cap body, and an operating end portion opposite to said cam end portion; and
wherein, when each of said suction units is in the non-sucking state, said operating end portion of said operating member is pivoted away from said cap body, and when each of said suction units is in the sucking state, said operating end portion of said operating member is pivoted toward said cap body, and an assembly of said connecting rod and said central portion of said sucking disc is moved away from the supporting surface, thereby forming a vacant space between said central portion of said sucking disc and the supporting surface.

10. The air spray gun assembly as claimed in claim 9, wherein each of said suction units of said supporting device further includes a coil spring disposed between and abutting against said cap body and said central portion of said sucking disc, and sleeved on said connecting rod for biasing said central portion of said sucking disc to move toward the supporting surface.

11. The air spray gun assembly as claimed in claim 9, wherein:
each of said lateral end portions of said central base body is cylindrical;
said connecting portion of said cap body of each of said suction units is in the form of a sleeve sleeved around the corresponding one of said lateral end portions of said central base body in a loose fitting manner; and
said suction base further includes two connecting pins each extending in a second direction perpendicular to the first direction and through a corresponding one of said lateral end portions of said central base body and said connecting portion of said cap body of a corresponding one of said suction units such that said suction units are pivotable relative to said lateral end portions of said central base body about said connecting pins, respectively.

12. The air spray gun assembly as claimed in claim 8, wherein:
said pivot groove in said central base body is defined by two parallel side walls opposite to each other in a second direction perpendicular to the first direction, and a groove bottom wall interconnecting said side walls, each of said side walls being formed with a plurality of positioning holes spaced apart from each other, said connecting end portion of said rod-mounting seat being connected pivotally between said side walls; and
said supporting unit further includes a positioning pin extending through said connecting end portion of said rod-mounting seat and engaging removably a desired one of said positioning holes in each of said side walls such that said rod-mounting seat is positioned at the desired angular position.

13. The air spray gun assembly as claimed in claim 12, wherein:
said positioning pin of said supporting unit has a head portion abutting against an outer surface of one of said side walls of said central base body of said suction base, and a threaded end portion opposite to said head portion and extending outwardly of said central base body; and
said supporting unit further includes a nut engaging said threaded end portion of said positioning pin and abutting against an outer surface of the other one of said side walls of said central base body of said suction base.

14. The air spray gun assembly as claimed in claim 8, wherein:
said air spray gun includes a hollow connecting body having a connecting rod, a gun body having a fitting mounted rotatably on said connecting body, and an air pipe mounted on said connecting body and in spatial communication with said fitting of said gun body; and
said gun-mounting unit includes
a mounting block sleeved movably and rotatably on said supporting rod, and formed with a through hole that extends in a third direction perpendicular to said supporting rod and that permits extension of said connecting rod therethrough such that said air spray gun is pivotable relative to said mounting block about a central axis of said connecting rod,
a first positioning member mounted on said mounting block and operable so as to position said mounting block at a desired axial position on said supporting rod, and
a second positioning member mounted on said mounting block and operable so as to position said air spray gun at a desired angular position relative to said mounting block.
